(19) United States
(12) Patent Application Publication
(10) Pub. No.: US 2014/0235159 A1
(43) Pub. Date: Aug. 21, 2014

(54) Vehicle Cellphone Blocker

(71) Applicant: Stephen Michael Komistek, Medicine Hat (CA)

(72) Inventor: Stephen Michael Komistek, Medicine Hat (CA)

(21) Appl. No.: 13/769,368

(22) Filed: Feb. 17, 2013

(51) Int. Cl. H04W 4/02; H04K 3/00

(52) U.S. Cl. CPC H04W 4/027; H04K 3/43; H04K 3/80
USPC 455/1; 455/418; 455/26.1

(57) ABSTRACT

A system or method that blocks the operation of a cellphone in a powered vehicle, so that the driver complies with the new cellphone legislation, that is coming into effect, or is in effect around the world, and provides additional safety assurance for family members, individuals, and employers.

The system will also emit a signal that allows law enforcement individuals to also identify that the system is in operation, and not turned off, or deactivated. The cell phone blocking system will only cover the internal area of the vehicle that affects the driver, and not affect cell phone coverage outside the vehicle.

### FIELD OF THE INVENTION

This application relates to the field of operation of cellphones within any powered vehicles, and more particularly to eliminating its usage inside the vehicle, while the vehicle is in motion.

Since the vehicle is in constant motion, a predetermined region of cellphone signal space cannot be specified, so the region of space is not limited where the cellphone signal will be affected. The region of space will be changing based on where the vehicle is located.

This application also relates to the field of operation for detecting, that the cellphone signal blocking mechanism is in operation, so law enforcement officials can easily determine, whether the device is activated. Law enforcement officers will be able to use a device, much like a radar detector to determine if the device is in operation and doing its job.

### BACKGROUND OF THE INVENTION

As the use of cellphones has increased, there are probably as many cellphones in use as there are powered vehicles.

While driving a vehicle, it is very important to have your attention focussed on the task at hand. It has been determined by many studies, that operating a vehicle, while using a cellphone is unsafe. Many studies show that your reaction time and attention to the road is greatly reduced when using a cellphone. In some studies, while operating a powered vehicle, it showed people that were impaired on alcohol, above the legal limit, did better than people using cellphones in a controlled test. It is getting to the point where many provinces, states and countries are banning the use of cellphones inside a powered vehicle.

Many parents have teenagers operating their vehicles, and they want their vehicles to be safe for their teenagers. A big concern for parents is that they want their teenagers to pay close attention to driving, because they are not yet experienced drivers, and any distraction, may lead to an accident.

We all as parents tell our teenagers to not text or use their cellphones while driving. Teenagers still use their phones regardless of what their parents tell them. It would be a big benefit for parents if they can prevent cellphone usage while the vehicle is in motion. Once the vehicle is safely stopped, then the cellphone usage would become available again, and this would make your cellphone available for emergency calls.

When driving somewhere with your kids it would be nice to take away their ability to text, because you don't get a chance to utilize this quality time to interact with your kids. They seem to be in a different world when they have their cellphone, and all their attention is on their cellphone and nothing else.

In some regions where cellphone usage is allowed, or a hands free device is legal, an on/off switch would be installed. This would allow the parents to prevent their teenager from using the cellphone while the vehicle is operated, and yet allow them use of their hands free cellphones when they are operating their vehicles.

Public transportation is another big concern for restricting cellphone usage. In some regions it is illegal for a person to drive a school bus and operate a cellphone. Us as parents have no control of ensuring that our children are safe, once they are placed on a school bus.

The bus driver still has the ability to use their cellphone while driving our kids, even though this act is illegal. A big vehicle is less forgiving than a small vehicle, and a minor distraction can lead to fatalities. There is a need to ensure that drivers of public vehicles are not distracted by use of their cell phones. There is a need to ensure that cellphones can't be used for any reason by a driver when a public transportation vehicle is in motion.

Business/Commercial owners that have fleet vehicles, most likely have policies in their safety manuals that state they do not want their personnel to operate their vehicles when using a cellphone. This would be put into their safety manuals for insurance and liability issues that might arise. The ability to show that they can guarantee that cell phone usage while driving a vehicle is not possible, by their employees, might help them reduce their insurance policy charges. Many business owners have vehicles that are worth more than $300,000, and I am sure that they want their employees to pay as much attention as possible to their driving. The company has a chance of incurring costs for accident repairs, increases in insurance, as well as lost revenue while the equipment is out of service after an accident. They would have a direct need for not having their employees have access to a cellphone while driving.

Having a ban on cell phones usage in moving vehicles is hard to enforce unless there is a process in place that provides controls. There are not enough police to enforce these rules, so equipment, and a process to immobilize the use of cellphones is required. There also has to be an easy way to enforce compliance so people don't have the ability to disconnect the signal blocking device. The device and process that I am proposing satisfies both conditions. (FIG. 3)

### DESCRIPTION OF PRIOR ART

I did a patent search and there are no known patents that address this issue. The reason there is no patents is because firstly there was no need to ban the use of cellphones in a powered vehicle. Legislation is in effect or coming into effect throughout the provinces in Canada that will be banning cellphone usage in a motor vehicle. Secondly the use of jammers to eliminate cell phone usage in various areas was illegal.

Cell phone jamming devices (FIG. 2) are an alternative to more expensive measures against cell phones, such as Faraday cages, which are mostly suitable as built in protection for structures (FIG. 1). New cars can implement Faraday cages as one alternative for impeding the incoming signal to the cellphone. The disadvantages are that you would not be able to access your cellphone inside the vehicle in an emergency and they are expensive. The cellphone jammer is still the best alternative, but it is illegal to use in Canada.

The reason the jammer is banned is because no one has the right to impede the air signals that are coming to another individual. In the case of a vehicle, the vehicle owner should have the right to turn off the signal in their vehicle, much like you have the right to turn off your phone. The vehicle owner also has the right to dictate to the people in their vehicle conditions that the driver or passengers must abide to if they want to ride in their vehicle. The individual has the right to accept the conditions to ride, or refuse the ride.

Now that the government is legislating no cellphone use in a vehicle, legislation will have to be changed to allow jamming devices to be installed in vehicles, so that they can enforce the cellphone law. It would not be a big move for legislation to allow jammers to just cover the drivers air space in a vehicle, especially if it helps law enforcement people do their job.

Once my patent is approved in concept I would lobby to get jammers legalized for in car usage. Since this request would be aiding to enforce current legislation, and it does affect the intent of the law on jammers, I do not for see any issues getting an approval.

There is a patent pending (Patent Application 2367432) that controls the use of electronic devices in a predetermined region of space. It was filed in 2000 Apr. 28 and was never approved, probably because what it was trying to do was illegal and an infringement on human rights. Basically they wanted to be able to control electronic devices in a predetermined public area, so that these devices would not be a nuisance to other individuals. For example they would like to disable the ringing feature of a cellphone, so the ringing would not be a distraction to others. They are trying to control the airwaves in a predetermined region of space, like a school, theatre etc. They proposed changing particular operating functions of electronic devices, and not implementing the use of signal jammers, or shielding of the area to prevent use of a cellphone.

The difference with my patent is that I want to be able to aid present legislation and only in a powered vehicle. The vehicle is in constant motion and it is acting in an undetermined region of space with the air waves, and cell towers that come in range of the cellphone. My application only affects the individual and provides them with an extra level of safety for their families and employees. What I am proposing does not affect any individual's rights or privileges, and it will aid current legislation.

### SUMMARY OF THE INVENTION

The invention eliminates the cellphone reception in the vehicle, such that the driver cannot use their cellphone while driving. Once the vehicle comes to a complete stop the cellphone would become available for usage. This scenario would be for when legislation makes cellphone usage illegal.

When hands free cell phone usage is legal, the invention will have a lockable on/off switch, that will allow the individual to use his hand free operation and receive a cellphone signal.

When cellphone usage is legal, the invention will have a lockable on/off switch, that will allow the parents of a vehicle, or employer to lock out cellphone reception if they think it may be distracting for the driver of their vehicle.

In regions where cellphone usage is illegal, the invention will have provisions that it will employ a signal emitter(SE), that will indicate that the cellphone signal has been blocked or the cellphone has been turned off. This signal can be easily detected by law enforcement officials, so that they can determine if an individual has access to their cellphone signal while driving a motor vehicle. In the future I can see legislation being brought in that requires a signal emitter, if all vehicles must employ a cellphone blocker.

### BRIEF DESCRIPTION OF THE DRAWINGS

FIG. 1 is a drawing of driver compartment with shielding.

FIG. 2 is a drawing of driver compartment with a jamming device.

FIG. 3 is a drawing of a driver compartment with a signal emitter.

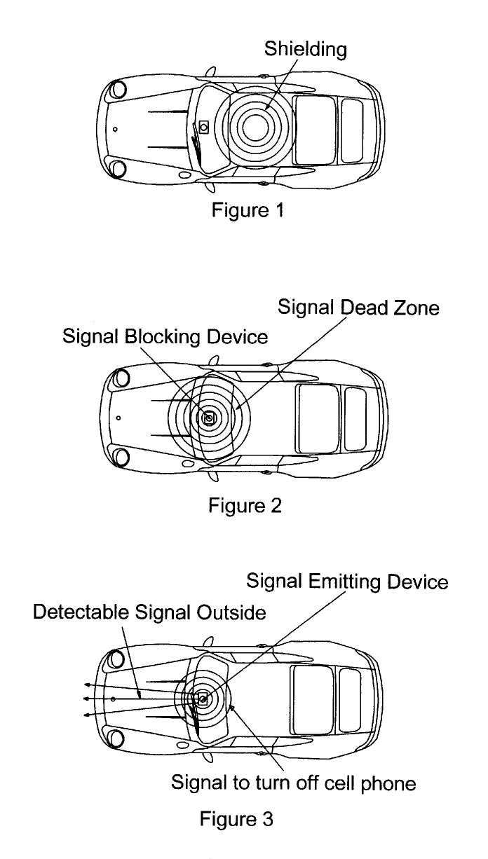

The embodiments of the invention (vehicle cellphone blocker) in which an exclusive property or privilege is claimed are defined as follows:

1. A system for defining a mode of operation for a device(s) in a powered vehicle when it is in motion in an undetermined/changing region of space, the system comprising of one or a combination of the following:
a) cell phone Signal Blocking Device(SBD).
b) a signal emitting device(SEDo), that is detectable from outside the vehicle.
c) an external signal receiving device for law enforcement, that depicts whether the SBD is activated.
d) an on/off lockable switch for the SBD.
e) cellphone signal shielding system around the passenger compartment.
f) cellphone signal absorption properties built into the vehicle.
g) a signal emitting device(SEDi), that works inside the vehicle to power down the cellphone.

2. A system as in claim 1, whereas the signal blocking device (SBD) may emit a frequency signal, radar signal, microwave signal or other signal, or any other type of disruption, that will block or disrupt the use of a cellphone.

3. A system as in claim 1, whereas the signal blocking device may be a shielding device such as a Faraday cage or any other adequate shielding system that will eliminate or disrupt a signal coming to the cell phone, by shielding the passenger compartment.

4. A system as in claim 1, whereas the signal blocking device may be a cellphone signal absorption barrier that surrounds the passenger compartment and that will eliminate or disrupt a signal coming to the cell phone.

5. A system as in claim 1, the Signal Emitting Device (SEDo) will transmit a type of signal outside of the vehicle, that will be detectable over a long distance, it may be a frequency based signal, radar signal, microwave signal or other type of signal that is measureable.

6. A system as in claim 1, whereas the Signal Blocking Device, will turn off when the vehicle comes to a complete stop, or when the vehicle is turned off, or the vehicle is put in park, or any combination of these 3 options.

7. A system as in claim 1, whereas the Signal Blocking Device, and the Signal Emitting Device (SEDo,SEDi) may be combined into one unit, or may be two separate units.

8. The Signal Blocking Device (SBD) signal will be contained in the vehicle, such that it has no effect on any cellphones outside of the powered vehicle. The SBD will not affect any public airwaves.

9. The Signal Blocking Device (SBD) may incorporate a signal adjustment, so that the signal can be changed to adjust to the shape of the interior of the vehicle.

10. The process of using a low range signal jammer to eliminate or restrict a cellphone signal in a powered vehicle may be used.

11. Incorporating a Signal Emitting Device (SEDo) to emit a certain type of signal if the Signal Blocking Device is not operational, or has been tampered with, so that law enforcement can identify vehicles that are perhaps breaking the law.

12. A Signal Emitting Device (SEDi) that works in conjunction with the cellphone, such that it will automatically turn the power off in the cellphone in the vehicle passenger compartment, and not allow it to be powered up until the vehicle is in park, comes to a complete stop, or the vehicle is turned off, or any combination of these 3 options.
